(19) United States
(12) Patent Application Publication
(10) Pub. No.: US 2019/0112231 A1
(43) Pub. Date: Apr. 18, 2019

(54) COMPOSITION AND METHOD FOR MAKING SELF ADHERING CONCRETE AND SYNTHETIC SEDIMENTARY ROCK FROM CEMENTITIOUS MATERIALS

(71) Applicant: Evan Daniel Vokes, Didsbury (CA)

(72) Inventor: Evan Daniel Vokes, Didsbury (CA)

(21) Appl. No.: 15/787,687

(22) Filed: Oct. 18, 2017

(51) Int. Cl. C04B 28/04; C04B 14/06; C04B 18/14; C04B 24/28; C04B 14/04; C04B 41/00; C04B 41/50; C04B 41/65

(52) U.S. Cl. CPC C04B 28/04; C04B 14/06; C04B 18/146; C04B 24/286; C04B 2111/72; C04B 41/009; C04B 41/5079; C04B 41/65; C04B 14/045

(57) ABSTRACT

A cementitious material made from industry accepted precursor materials that will adhere to existing concrete or rock has several exploitable features beyond adhesion. The primary motivation for the invention was a self-adhering thin overlay of quality better or equal to the parent concrete floors is now possible. Structural repair of concrete is possible. There are a range of compositions and exploitable features than can be used to give the product flexibility across many concrete repair applications. This resulting material can demonstrate the low permeability and high strength closer to natural stone materials such as quartz and dolomite rocks than to concrete but intermediate compositions are technically viable as well. The material can be used for high quality precasts.

### STATEMENT OF FEDERALLY SPONSORED RESEARCH

No Federally sponsored research was used

### STATEMENT OF NAMES OF PARTIES OF JOINT RESEARCH

No joint research parties were involved in this invention

### INCORPORATION BY REFERENCE

a) Polycarboxylate superplasticizer admixtures: Effect on hydration, microstructure and rheological behavior in cement pastes
b) Unlocking the secrets of Al-tobermorite in Roman seawater concrete
c) Silica Fume User Manual
d) The Geometry and Petrogenesis of Dolomite Hydrocarbon Reservoirs

### STATEMENT OF DISCLOSURES

The patent claims that a novel method of using common concrete materials and additives can result in a new materials and physical phenomenon. The inventor Evan Vokes knew of no prior art that pertained to this invention and is not an improvement of existing technology. This was further confirmed by multiple searches by Parlee law for the original provisional patent. There are no known commercial or patent claims offered by others technology that assisted in development of this novel idea as all manufacturers claims do not include this phenomenon. There was no public disclosure or offer for sale. I did work with some industry people to obtain unique materials and information that are hard to procure on a need to know basis but only Altamix has seen part of the process.

### BACKGROUND of INVENTION

### Technical Field

Embodiments herein relate to cement compositions and more particularly to compositions for bonding said compositions to other cement or creation of new products from these cement compositions.

### BACKGROUND

There is sometime a need to adhere a new concrete composition to existing surfaces including too old, cured cement. To date the use of polymer adhesives to approximate adhesion or bonding cement-to-cement has been a challenge, resulting in variable success at best. The applicant noticed that although new concrete is considered to be chemically dead to old concrete, he had personally observed chance adhesions in past years but no literature or products were reflective of this phenomenon as it is accepted as an engineering tenant that concrete does not bond to existing concrete.

As discussed in a December 1997 article “Effective Use of Bonding Agents”, a Construction Technology Update No. 11, by Mr. Noel P. Mailvaganam of the National Research Council of Canada (the NRC Article), two of the critical factors affecting the bonding between new and old concrete are (i) the strength and integrity of the old surface and (ii) the cleanliness of the old surface. As one has come to expect, the surface condition plays a critical role in bond development, although the strength of the bond also depends on other factors such compaction of the new concrete and proper surface preparation that takes into account the density of the base concrete. Known surface preparation includes acid etching of the base concrete, while mechanical cleaning will be essential if the old concrete contains a weak or deteriorated surface. The NRC Article identifies the main types of bonding agents used in the construction industry as latex emulsions and epoxies. The NRC Article notes that while good adhesion may be obtained without a bonding agent, generally a bonding layer consisting of cement and sand slurry, cement/latex slurry or epoxy increases bond strength.

The NRC Article identifies latex bonding agents including Styrene Butadiene (SBR) latex and Polyvinyl acetate latex (PVA).

Styrene butadiene (SBR) latex, which is compatible with cementitious compounds, is a copolymer. This type of latex shows good stability in the presence of multivalent cations such as calcium (Ca2+) and aluminum (Al3+), and is unaffected by the addition of relatively large amounts of electrolytes (e.g., CaCl2). SBR latex may coagulate if subjected to high temperatures, freezing temperatures, or severe mechanical action for prolonged periods of time.

Two main types of PVAs are used in repair: non-re-emulsifiable and emulsifiable. Non-re-emulsifiable PVA forms a film that offers good water resistance, ultraviolet stability, and aging characteristics. Because of its compatibility with cement, it is widely used as a bonding agent and as a binder for cementitious water-based paints and waterproofing coatings. Emulsifiable PVA produces a film that can be softened and re-tackified with water. This type of latex permits the application of a film to a surface long before the subsequent application of a water-based overlay. Its use is limited to specific applications where the possible infiltration of moisture to the bond line is precluded. It is most widely used as a bonding agent for plaster, and to bond finish or base-coat gypsum, or Portland cement plaster, to interior surfaces of cured cast-in- place concrete. Acrylic ester resins are polymers and copolymers of the esters of acrylic and methacrylic acids. Their physical properties range from soft elastomers to hard plastics. This type of emulsion is used in cementitious compounds in much the same manner as SBR latex. Epoxy emulsions are produced from liquid epoxy resin mixed with the curing agent. In addition to serving as an emulsifying agent, the curing agent also serves as a wetting agent. From the time of mixing until gellation occurs, the emulsions are stable and can be diluted with water. Pot life can be varied from 1 to 6 hours depending on the curing agent selected and on the amount of water added. Most epoxy emulsions are prepared on the job site just before use because phase separation occurs in prepackaged emulsions. Equal parts of epoxy and curing agent are mixed, then blended for 2 to 5 minutes and allowed to set for 15 minutes to enable polymerization to begin. While the mixture is being mechanically agitated, water is added slowly to form the emulsion. As an alternative to these liquid-based systems, which require on-site measurement and pre-dilution, it is now possible to obtain factory-blended powders containing a mixture of cement, spray-dried latex powders, sand and other additives, which are simply mixed with water on site. The resultant “stipple” finish provides a good “key” for repair mortar or overlays. The stippled grout coat minimizes the loss of water from the overlay to the substrate, preventing desiccation of the cement and the resultant poor bond. Although the grout coat does provide points of anchorage for bonding, the application of the repair mortar or overlay while this key coat is still tacky is strongly recommended.

Various epoxy products are available for the bonding of freshly placed concrete to cured concrete and of concrete to steel. Most products contain resins that are 100% solids. They may or may not contain fillers, such as calcium carbonate or silica flour, and other additives to enhance a particular property or reduce cost. Products are available in a variety of consistencies, ranging from a highly filled paste (for overhead work) to liquids with a viscosity of 100 cp (0.1 Pa·s), which is similar to that of water. Because the formulations can combine different resins, hardeners and modifiers to produce a great variety of end products, the user and specifier need guidance on the options available to them. The ASTM standard ASTM C881-78 “Epoxy-resin-based Bonding Systems for Concrete” is quite informative in this respect. It is a performance specification based on end use and there are no specific limits on chemical composition. Instead, the material selected must meet requirements related to physical properties such as viscosity, bond strength, shrinkage and thermal compatibility. The specification classifies the epoxy-resin bonding system by type, grade and class. The type is determined by end use (see ASTM C881, Table 1, “Physical Requirements of Bonding Systems”). Systems can be summarized as follows: Type I, for bonding hardened concrete and other materials to hardened concrete; Type II, for bonding freshly mixed concrete to hardened concrete; Type III, for bonding skid-resistant materials to hardened concrete (or for use as a binder in epoxy mortars or concretes).

The NRC Article concludes that critical factors governing the achievement of an effective repair is good adhesion at the interface of the repair material and the concrete substrate and that a proper bond between the repair material and the substrate can be obtained by surface preparation, consolidation and curing—all without the use of bonding agents. However, bonding agents play a significant role where it is critical to ensure bond at the interface.

Applicant understands from the above that the primary bonding mechanism of the above is mechanical and thus is inherently less competent that the base concrete and susceptible to water migration damage. Regardless if one applies an epoxy or a latex based admixture, the use of polymer admixtures is limited to specific applications where the possible infiltration of moisture to the bond line is precluded. Therefore, there is interest in the industry to seek mechanisms for bonding that overcome the issues associated with bonding agents.

There exists an overlay industry where a thick layer of concrete is poured directly on top of existing concrete. There also exists a wealth of information on the internet about its limited usefulness and applicability which precludes the necessity of discussion in the context of VokeStone.

### SUMMARY

Generally, in embodiments disclosed herein, a bonding mechanism is disclosed which results in an improved interface. In concrete-to-concrete embodiments, the interface can be more competent than that of the base concrete. Applicant has effected a change from the conventional hydration bonds of semi amorphous Calcium Silica Hydrates to the precipitation of carbonates and with further treatment to the precipitation of minerals in the composition and at interfaces to existing structure and across interfaces to existing concrete or within the volume of concrete.

Applicant's research was initially directed to the top-coating, recoating or repairing the surface of prior concrete floor surfaces through the application of an added cementitious composition. Applicant attempted both new combinations of additives, added to the new concrete, and to new methodologies for enhancing bonding. Further, for floor finishing embodiments, Applicant was aware of the objectives and potential conflict between ease of finishing the new concrete and its ability to bond with the old concrete.

In embodiments, Applicant has determined that a cementitious composition exhibiting, bonding characteristics and a surface quality superior to that of base concrete, comprises Portland cement, pozzolanic material and sand combined with a superplasticizer such as Poly Carboxyl Ether. The interface between the new composition and the old base concrete may be initially mechanical but, over time, develops a full chemical bonding interface to form. Used for flooring and other surface requiring enhanced finishing, the resulting cement can be finished. Further, the surface retainer reinforcing micro bars in the finished surface for a safe and uniform finished surface without releasing micro bar ends to project out of the surface. Further adhesion advantage is achieved when aggregate in the parent or base material is exposed which does not induce sub-surface damage using techniques, such as through mechanical abrasion or weathering. In other embodiments, the composition has proved to exhibit a strong bond to other materials including steel or expanded polystyrene but no adhesion to polymers such as ABS or polyethylene. The composition is also formable and amenable to post-forming finishing.

The most viable of the overlay mix designs demonstrate long range crystallinity with a rock matrix of silicates and carbonates, typically quartz, calcite and dolomite, while other phases are both possible. The chemical reactions of the mix design is unverified at this time but data analysis appears to be controlled by PCE which mechanical testing showed a medium correlation between strength and PCE across the same ratios of aggregate, pozzolan and Portland. Tests also showed that sodium silicate did not determine the initial adhesion as tests without the PMT admixture but XRD of these mixtures did show that the interface was magnesium calcium carbonate, which is not the crystalline mineral that the chemically similar dolomite is. Sodium silicates long term actions of promoting the conversion of magnesium calcium carbonate into Dolomite as well as the other mineral conversions attest to its usefulness of commercialization considerations. As matrix strength rises, the sand component becomes indistinguishable from the basic cement matrix when sodium silicate is added. The formation of these phases pushes the long range crystal order across the bonding interface over time. While mechanical bond is exhibited in days, full chemical bonds developed well into the parent material within a week or more slowly over time dependent on chemical and water composition used.

As conventional concrete is hydrated amorphous rings, the strength of traditional concrete relies on the aggregate strength. In this case, we use much more sand than traditional mix designs and utilize precipitated mineral matrix to provide strength.

Applicant will use this rock as a synthetic “sedimentary” rock under the trademark VokeStone™ (Evan Vokes).

As a result, embodiments of cementitious compositions result in the following features:

a) Unprecedented adhesion of concrete to concrete by precipitation reaction.

b) Functionally structural thin overlays or bond coats are possible.

c) Functional in-situ concrete repairs are possible.

d) Synthetic rock (VokeStone™) is created in embodiments having low permeability, high strength; and

e) Pre-formed cement-derived products may be created.

### BRIEF DESCRIPTION OF THE DRAWINGS

FIGS. 1A and 1B are a flow chart of stagewise admixing of components to obtain the desired formulation and products that result therefrom;

FIG. 2A is a secondary electron image, from an SEM, at a bonded interface of new sodium silicate enhanced composition to an old concrete;

FIG. 2B is an X-Ray map from an SEM at a bonded interface of new sodium silicate enhanced composition to an old concrete;

FIG. 3 is a table of the crystalline components for a new sodium silicate enhanced composition to an old concrete;

FIG. 4 is an X-Ray diffraction image of the bonding interface of an embodiment of the new composition and the cement matrix of old concrete;

FIG. 5 is an X-Ray diffraction image of the bonding interface of an embodiment of the new composition and a discrete aggregate face in old concrete.

### DETAILED DESCRIPTION OF THE PREFERRED EMBODIMENTS

As stated above, in embodiments, one form of cementitious compositions comprises Portland Cement, pozzolanic material and sand combined with a superplasticizer such as Poly Carboxyl Ether and the use of a proprietary sodium silicate derivative, Pozzonlanic Mix Treatment, (PMT) in some compositions. Some understanding of the standard engineering nature of concrete is required to point out the differences. Concrete may be defined as an aggregate held in place by a matrix of semi amorphous hydrated rings of Calcium Silica Hydroxides. It is well known that the strength of concrete is the strength of the aggregate. This accepted engineering tenant is very different than what VokeStone has achieved

Portland cement—provides CaO or lime portion needed for binding clay and silicates together. A European standard defines Portland cement as a hydraulic material which shall consist of at least two-thirds by mass of calcium silicates (3 CaO.SiO2 and 2 CaO.SiO2), the remainder consisting of aluminum- and iron-containing clinker phases and other compounds. It is well established that Portland cements are the chemical reagent that makes concrete possible, In the case of VokeStone; we are concerned with the difference between the Alite and Belite allomorphs of this commodity notated in cement science as CS3 and CS2 respectively. The Belite allomorph is the preferred cement for VokeStone and is often referred to as Sulfate resistant Portland. The Alite allomorph is more common in industry, where it is known a general purpose Portland, since it sets much faster but there are other considerations related to the chemistry and morphology that must be considered for VokeStone. Alite has been successfully tested but Belite is the more functional allomorph.

Adding Pozzolanic materials to concrete is recognized as binding clays and silicates to the CaO. ASTM C618 prescribes that a pozzolan should contain SiO2+Al2O3+Fe2O3≥70 wt. %. Fly ash is often used in combination with Portland cement (in the order of 30% by wt) as a pozzolan to produce hydraulic cement or hydraulic plaster and a replacement or partial replacement for Portland cement in concrete production. Sales literature often identifies to use of Pozzolan's to ensure the setting of concrete and plaster and provide concrete with more protection from wet conditions and chemical attack but Pozzolans can damage concrete just as easily. At the risk of oversimplification for the purposes of this embodiment, Industrial Pozzolan products are essentially reactive fine silica with heterogeneous allomorphs. Fly ash is the most common and is characterized as fine silica with a high degree of crystallinity. Conversely, the chemically similar Silica Fume is typically produced by rapid cooling so that a mainly amorphous quenched glass or simply stated limited crystallinity. Blast Furnace slag pozzolans are similar although the method of production is radically different. In practice all the Pozzolans are heterogeneous. As an example, fly ash is a heterogeneous material. SiO2, Al2O3, Fe2O3 and occasionally CaO are the main chemical components present in fly ashes; but the Pozzolan relationship VokeStone needs appears to be is the total presence of both amorphous and crystalline silica phases as well as magnesium content. Specifying materials used to get to this goal are not as important as what the full combinations of materials are.

For instance the mineralogy of fly ash is very diverse. There are two types of fly ash:
Class F fly ash. This fly ash is pozzolanic in nature, and contains less than 7% lime (CaO). Possessing pozzolanic properties, the glassy silica and alumina of Class F fly ash requires a cementing agent, such as Portland cement, and
Class C fly ash generally contains more than 20% lime (CaO). Unlike Class F, self-cementing Class C fly ash does not require an activator. Alkali and sulfate (SO4) contents are generally higher in Class C fly ashes

For VokeStone, there is no guarantee that these materials that meet the ASTM standards for both classes of flyash would work. Rather they must be investigated for the correct properties as one of the ingredients of VokeStone is not required to be present in the ASTM standard analysis.

All the dry ingredients were subjected to XRay Florescence as XRay Diffraction gives little information on what elements are present. The finding is that the undeclared Magnesium content was significant in many samples. It is safe to say that the correlation between material combinations that maximized magnesium content, and adhesion was very strong. All these raw materials were less than 5% magnesium whereas magnesium carbonates themselves are 13% magnesium. There is no kinetic chemical path for the raw materials to form magnesium carbonates on their own even if the path is thermodynamically favored so reagents and catalysts are required.

Superplasticizer—also known as high-range water-reducers, are chemical admixtures including polymers used where well-dispersed particle suspension is required. A current embodiment includes polycarboxylate ether-based superplasticizers (PCEs) which are discussed in detail for industry accepted use in January 2005 paper by F. Puertas Polycarboxylate superplasticizers admixtures: Effect on hydration, microstructure and rheological behavior in cement pastes.

The paper summarizes known effects of PCE demonstrating the industry accepted method that a relatively low dosage (0.15-0.3% by cement weight) the PCE superplasticizers allow a water reduction up to 40%, due to their chemical structure which enables good particle dispersion.

In this application the PCE is used at a very high rate of 3.0-4.5% by cement mass or 1.6-16.0% by water mass. The optimum engineering ratio of Portland cement type product to water is defined as a W/C ratio of 0.25 by mass. It would be assumed that water alone, is the factor that determines strength of standard concrete matrixes that support the aggregate, hence the accepted engineering tenant is that lowering the water content is an essential variable when seeking to increase the strength of the resulting product. In the case of VokeStone lowering the water did not exclusively result in the strongest test results, rather, water/cement rations between 0.30-0.36 in conjunction with PCE doses over 10:1 water to PCE ratios resulted in the maximum compressive strengths. There are an infinite number of mid steps that can be achieved with water to cement to PCE ratios.

PCE has another very strong effect where it keeps Ca2+ ions from reacting. This effect appears to be important as the observation is that the thermodynamically less preferable MgCO3 (−1095 kJ/mol) complexes to precipitate before the less desirable CaCO3 (−1206 kJ/mol).

Sodium silicate, or water glass, generally has the form of Na2(SiO2)nO. In liquid form, for ease of mixing, Sodium silicate is a mixture of caustic soda, quartz sand, and water are mixed than fed into a reactor, where steam is introduced. The reaction is n SiO2+2NaOH→Na2O.nSiO2+H2O. Sodium silicate can help to reduce porosity in masonry products. Sodium silicate is typically only applied as a surface treatment. A chemical reaction occurs with the excess Ca(OH)2 (portlandite) present in the existing concrete that permanently binds the silicates with the surface, making them far more durable and water repellent. This treatment generally is applied only after the initial cure has taken place.

Sand was found to be a very important component for the VokeStone. It was observed that without sand, the cream of the mix would not react and harden. Further testing showed that pure silica sands that were deficient in Magnesium content did not perform to expectations. The mechanisms of crystal growth are well established and it appears that the sand in conjunction with the fine silica provide nucleation sites for crystal growth. There is an unknown if the sand is required to nucleate precipitation of magnesium compounds or if there is an overall critical value of magnesium content required for the reactions to proceed. It is unknown if doping the mixture with Magnesium compounds would overcome the limitation.

One of the resultant components, Dolomite is a calcium magnesium carbonate with a chemical composition of CaMg(CO3)2 and a heat of formation of −2660 KJ/mol but there exist no laboratory experiments to prove the formation of Dolomite from the theoretical precipitation to reality. This geoscience subject referred to as the Dolomite Enigma was reviewed extensively by Braithwaite in the Geological Societies 2004 title, The Geometry and Petrogenesis of Dolomite Hydrocarbon Reservoirs. Not only does this reference to the Dolomite Enigma remain current but the problem is widespread in Geosciences. There is no term to describe the conversion of chemical compounds into mineral. A quick google search will show that one of the few man made minerals that mimics nature is diamond. While Calcite is a known product of sodium silicate cement chemistries, the presence of Quartz that was not present in the precursor materials so the presence of quartz with no know chemical path is also an enigma in VokeStone. The presence of the quartz is harder to comprehend as so many of the precursor materials are silicates whereas, magnesium is easier to follow the chemistry path to crystallization. VokeStone appears to have a strong correlation to solving the Dolomite enigma.

The parent or base material the overlays were developed on had a concrete admixture containing high quantities of sulfur precluded finishing the surface. Both mechanical methods of scarifying and diamond grinding of the surface resulting in unreliable or complete failure of embedded micro rebar reinforcements to grind off flush with the concrete itself. Further, epoxy and urethane coverings were investigated and were confirmed as unsuitable for effective restoration of a functional work surface. Accordingly, compositions with sulfur are discouraged.

Once mechanical surface remediation failed, different silicate-based products were tested. Commercial admixtures were tested, using Portland Cement, Sand and aggregate particularly in embodiments touted as suitable for forming thin coatings bonded to old concrete. Successful adhesion was not achieved.

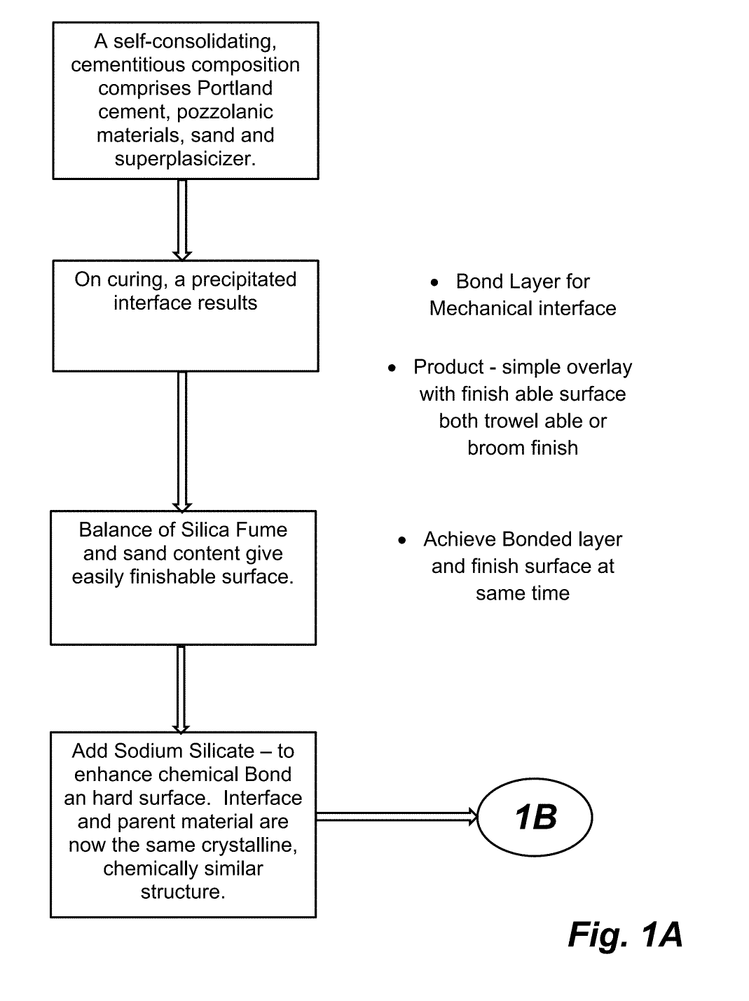

With reference to the flow chart of FIGS. 1A and 1B and as discussed, embodiments of a self-consolidating, cementitious composition are provided comprising Portland cement, pozzolanic materials, sand and superplasticizer. On curing, a synthetic stone with a precipitated interface results. The use of aggregate is of economic necessity as the mix design is very expensive compared to industry standard concrete mixes. At the time of this application, Applicant understands the precipitated interface to be largely composed of quartz and carbonate materials but thermodynamically other precipitates are possible. The initial result is a bond layer that exhibits at least mechanical bond interface superior to prior interfaces. There are numerous chemical and mechanical variations that can be applied to change the performance to make it more application specific. For instance, the addition of greater amounts of sand and silica fume, further enhance the surface finish through techniques including float and troweling. Crack load carrying may be improved by reinforcement such as micro reinforcement bars.

In improved concrete-to-concrete interfaces, additives from the sodium silicate family can be added to enhance chemical bonds through precipitation and crystallization at the bond interface. Over time, sodium silicate containing mixes will chemically bond across the interface. Once bonded, the Interface and parent material are now the same crystalline, chemically similar structure. PMT is preferred chemical available from Enhance ICD (Canada) Inc, and is provided in liquid form, but other companies offer similar proprietary admixtures. Investigation during the provisional application showed that the PMT additive claim is that it accelerates “rigidity” and “densifies”. A further manufacturer caution is that PMT should not be mixed with polycarboxylate admixtures but no reason was given for this statement. Commonly, the experience of users with PMT is that there is no bleed water, mix is extremely workable, sets up faster, successive coats or pours can commence sooner, and forms can be stripped earlier. These are the same functional properties claimed by vendors of PCE as both compounds have a proven record of increasing the utilization rate of Portland cement. It is well known that Sodium silicate effects water seals by forcing the precipitation of Calcium carbonate on existing concrete by scavenging unreacted Portland to form a Calcite crystal structure that seals porosity.

Part way through the development process, the vendor of PMT sent a lab result to extol the strength virtues of PMT that showed that trace minerals of Jennerite and Tobermorite had formed in one of their tests. When I sent my samples for XRD, I asked them to specifically look for these minerals. The answer from XRD was VokeStone is substantially different as these minerals were never observed.

In more detail of the path of the invention, after all industry ideas to repair the floor were exhausted, the inventor started with cement materials that were used to cast the original floor, CSA type 50 Portland, Sand and 10 mm aggregate. Combinations of PCE and PMT were tried but no success was obtained. Research indicated that a flyash and silica fume may have been useful but are difficult to obtain in less than bulk loads of product. Subsequently, a unique cementitious composition was implemented utilizing a bag of commercial type GU Portland cement, a bag of commercial SAKRETE (Registered trademark of Sakrete of North America, LLC), a super plasticizer and sodium silicates. Applicant was informed by the vendor that commercial yet proprietary formulations SAKRETE also include about 30% pozzolanic materials with an included plasticizer but very low percentages of Portland. Accordingly, the SAKRETE component was only used to supply a simple source of Fly ash equivalent useful in the research when mixed with additional general purpose Portland to bring the cement component up to a reasonable level. This resulted in the first successful adhesion but no useable surface and removal was characterized by the preferential removal of the parent material as opposed to removal of the overlay.

For control, after successful proof of concept testing, and further research, Type F fly ash (from LaFarge North America Inc.) was obtained and was subsequently used as an additive on remaining tests. As set forth above, many further set of samples were prepared utilizing a type F fly ash and LaFarge CSA type 50 Portland. Ultimately compositions were established that successfully adhered. Adherence was deemed successful when the sample was removable from the parent concrete floor three days subsequent to application; only by chipping, with a portion of the floor removed therewith.

Such successful samples had a hard black layer at the new/old interface. The hard black layer would form whether or not the sodium silicate derivative was used. While surface adhesion was reliably achieved, surface finish was not achieved at the same time, where the two properties remained mutually exclusive through several rounds of testing. Surface finishing was improved with the adjustment of additional elements. Namely, silica fume, (a pozzolanic material) and a very high sand ratio aided in surface finish at the same time as adhesion across a wide range of water and chemical compositions.

As above, pozzolans (first located near Pozzuoli, Italy) are understood to be a broad class of siliceous or siliceous and aluminous materials which, in themselves, possess little or no cementitious value but which will, in finely divided form and in the presence of water, react chemically with calcium hydroxide at ordinary temperature to form compounds possessing cementitious properties. Successful concrete, first used by the Ancient Romans (Roman Concrete), used volcanic ash (pozzolanic materials) as a key component and different effects came from different deposits. An excellent reference, Unlocking the secrets of Al-tobermorite in Roman seawater concrete by Marie D. Jackson etal in October 2013 details how the various Roman concretes were based on different amounts of crystalline or amorphous volcanic product and while the product was slightly crystalline, the strengths were low by modern standards. The conclusion was that seawater was the active ingredient but no evidence was supplied of how they came to this conclusion. While no one has exactly replicated Roman Cements, Pliny the younger and current materials science give the clues that make this invention possible. While the Roman concrete cannot be considered prior art as it is so different, in materials science there are two tenants that can be invoked: a) amorphous materials are considered reactive in the presence of the correct catalyst. b) crystalline materials serve as nucleation sites to further grow crystal structures.

A form of pozzolanic material is silica fume, also known as microsilica. Silica Fume is an amorphous (non-crystalline) polymorph of silicon dioxide, silica. It is an ultrafine powder collected as a by-product of the silicon and ferrosilicon alloy production and consists of spherical particles with an average particle diameter of 150 nm.

Through the addition of silica fume, surface hardness and finishing improved and, at the same time, adhesion was improved. As set forth in Table 2.4, section 2.4, Silica Fume Users Manual by the Silica Fume Association April 2005 silica fume has the highest amorphous SiO2 (85-97%) and therefore reactive content, of the common cement, binders and enhancers.

In enhancing the bond from a predominantly mechanical to a chemical bond interface, time was a factor. Typically in concrete construction, it is understood that concrete strength increases over time as hydration occurs. Herein, the bond interface adhesion develops over time. Two brands of Silica fume were tested and the brand with higher Magnesium content was significantly more effective than the brand with the more amorphous nature so the amorphous nature alone is not the only factor.

While researching surface finish, Applicant determined that poor initial results of the bond layer to a destructive bond test, improved over time when the swatches from Test 15 a&b were left on the floor due to time constraints. Previously, initial performance was only evaluated after three days which was determined by the hardening degree of the overlay but poor adhesion results of samples left for three days were markedly improved and successful at 10 days and later experiments showed that some compositions took over a month to adhere. The implication is that many of the earlier tests, deemed failures would have been successful if left for longer time periods. The later interface clearly included a crystalline phase.

Further, the interface, dark or black in appearance, was noted to be substantially continuous and that sand was hard to discern from the rest of the matrix. Holding broken interface samples to the sun showed that the matrix showed reflectivity of crystalline materials, the same as the cleaved aggregates.

In bonding to other old concrete surfaces, it was determined that the overlay experienced reduced adhesion resulting from attempts to bond to the existing concrete cream layers. Although the shear stress required to break the bond would exceed the industry accepted 200 kPa permanence threshold. Even adhering to an existing concrete cream layer would be considered a permanent repair, the interface readily tears off when subjected to shear stress on an industrial scale such as point loads from common floor jacks.

Removal of the cream layers of parent materials adds a level of complexity. If the existing cream layer is scarified, Scanning Electron Microscope SEM images of the interface showed damaged in areas below the grind level. Alternatively, pouring new compositions on exposed aggregate where the cream layer was removed on other samples showed good adhesion whether naturally removed or mechanically removed. Proper installation should include removal of the hardened cream layer whether by less coarse means including, shot blasting, diamond grinding or through natural weathering.

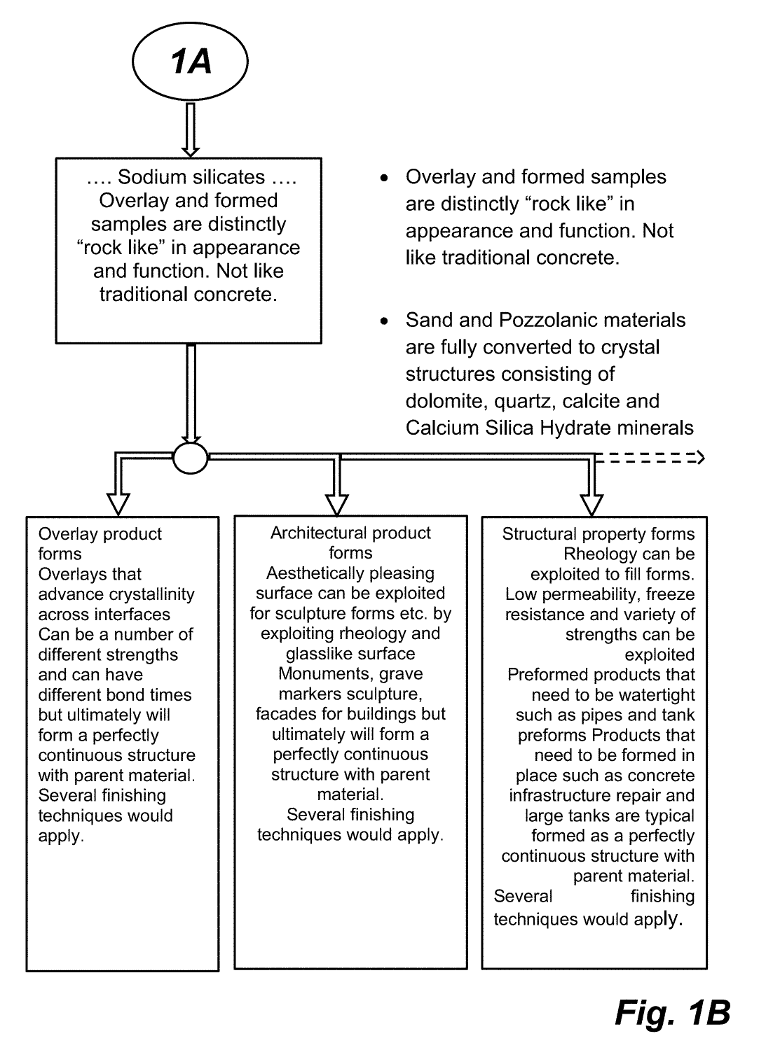

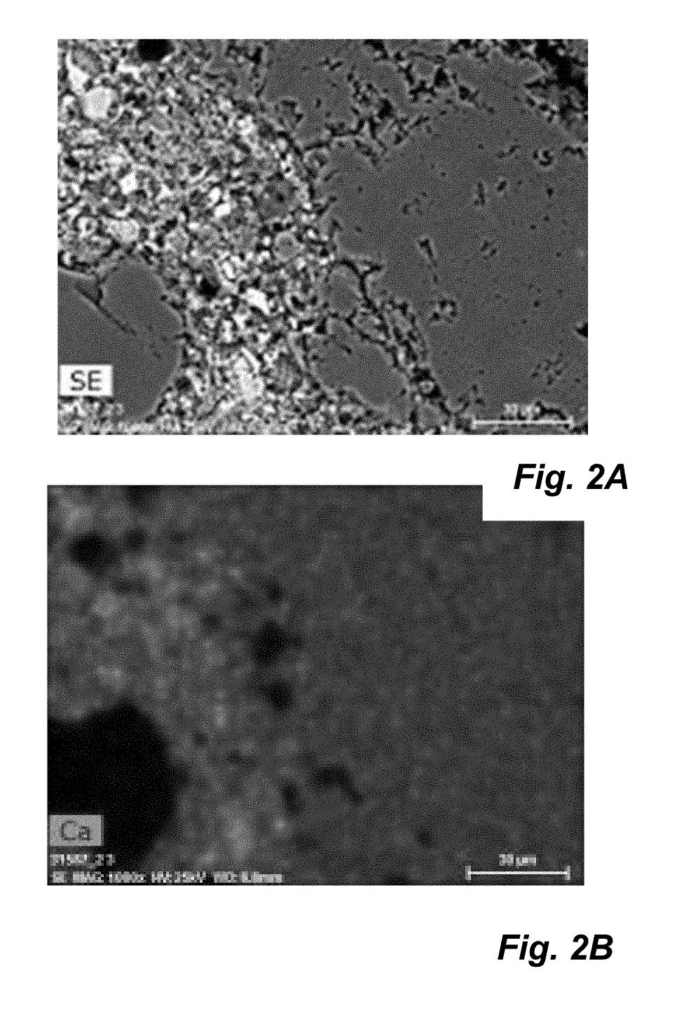

The physical manifestations of the bond have many unique implications. As shown in FIG. 2A, an SEM from a Scanning Electron microscope of a bonded interface of a base composition and pre-existing concrete, further comprises a sodium silicate additive, in this case PMT from Enhance ICD (Canada) Inc. The older parent concrete is shown at the right and new composition to the left, the crystalline nature of the chemically bonded interface clearly illustrated as the mottled and lighter gray area along an interface trending downward and right from left top corner to the bottom middle.

FIG. 2B is an X-ray map from an SEM of the same interface of a bonded interface, with the old concrete at the right and new composition to the left, the dissolution of the concentrated Ca in the parent material, shows the crystallinity moving left across the interface, from new to old, and consuming free Ca, resulting in crystalline interface bonding. The upper right, in the old concrete illustrates that most of the Calcium remains unused.

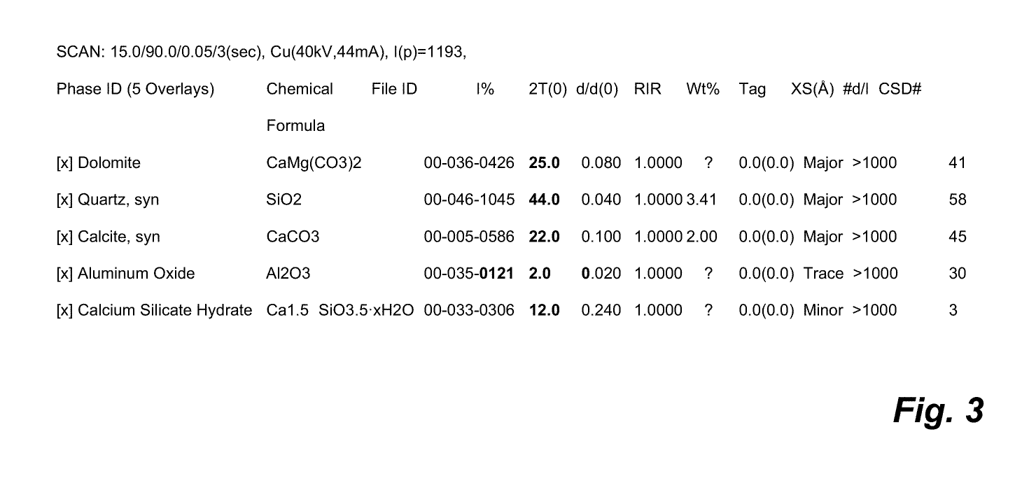

As shown in the Table of FIG. 3, a Spectrum Phase ID Report is provided for the composition at a concrete interface of a sodium silicate enhanced formulation bonded to old concrete. The results demonstrate each component presenting as crystalline for a completely crystalline interface. X-Ray diffraction only shows crystalline forms and while there is subjectivity in quantifying in XRD, the sums of the wt. % totals 100. The correct methodology to absolute mineral quantification is thin section but it is not required in this application.

As explained early in this application, conventional concrete is semi amorphous (non-crystalline) rings of calcium silica hydrate that support an aggregate. The table illustrates VokeStone as an almost complete conversion of a relatively normal concrete mix to synthetic sedimentary rock comprising Dolomite, Quartz, Calcite and Calcium Silicate Hydrate as the major phases as evidenced by XRD scans showing strong reflection lines with high crystallographic identifications and little background noise as compared to amorphous materials as evidenced by XRD of the precursor materials.

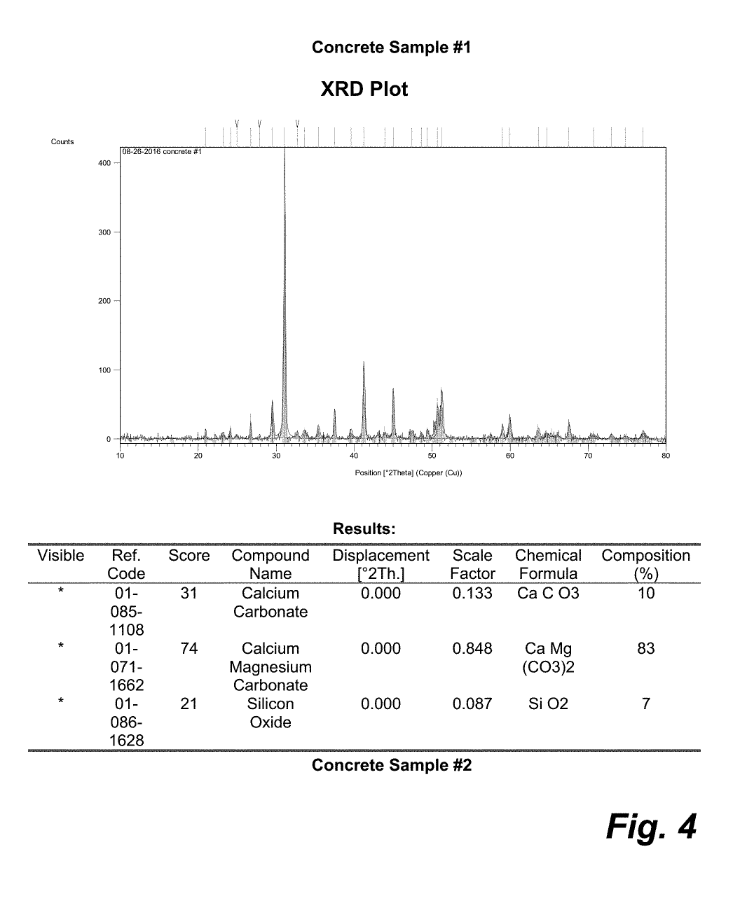

FIG. 4 is an XRD plot of a concrete sample with partial admixture load of the current embodiments. This is an embodiment of the composition without the sodium silicate additive. Superior adherence is provided but is not fully crystalline across the interface. The interface illustrates carbonates, precipitated early in the reaction. The samples are absent the PMT admixture but still adhere to the parent concrete.

While the sodium silicate free compositions are quite different than the preferred sodium silicate containing compositions of this group of mixes, they are still commercially viable for concrete bonding. Chemically they are the same as VokeStone but crystallization is different.

Applicant noted while pouring the nominal one inch thick overlays in the Styrofoam forms, some cement paste escaped the forms due to the uneven nature of the floor with no entrained sand. This cement paste did harden and bind to the parent floor but it took many months during the provisional period. This cement paste did not support timely precipitation without elevated levels of sand. In other words, the successful compositions required sand to enable crystal growth in a timely fashion.

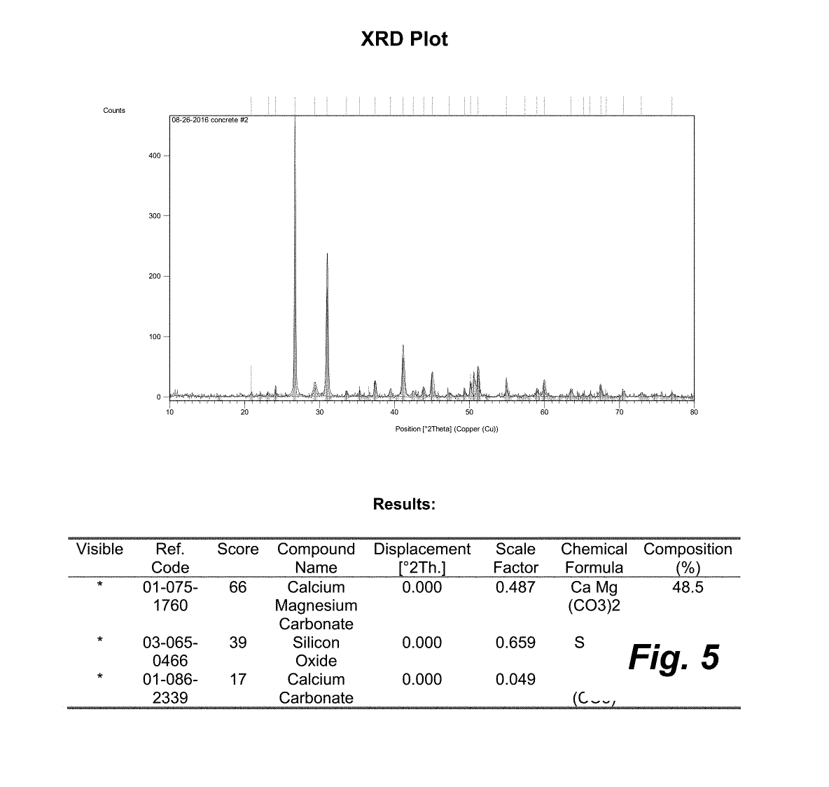

In FIG. 5, an XRD plot is shown of a second location in the sample of FIG. 4, the interface being unique located at the face of aggregate in the parent material. The results evidence the crystalline nature that is also observable with the naked eye when separated from the aggregate. The chemical reaction that makes the material consistent through the matrix resulted in less Calcium Manganese Carbonate at the rock interface rather than at the richer cement interface.

Other observations from the SEM included that problematic sulfur was confirmed as present in the parent material, but the rest of the chemical composition was uniform in the overlay, the interface and the surface of the parent material. The free Calcium of the parent material was absent from the interface and a uniform Calcium, Silicon, and Carbon distribution was present. Applicant believes that carbon chains in the plasticizers force a useful precipitation of carbonates into mineral form without adversely affecting the concrete. This reaction is thermodynamically probable as the PCE is known in literature to suppress Ca2+ ions from reacting for a time period whereas the PMT will react to form carbonates immediately.

The XRD results indicated this was in a form akin to an artificial sedimentary rock and the same crystal phases were present both sides and across the interface. Dolomite, Quartz and Calcite composed almost 100% of the new concrete of the overlay, and in the parent material surface. While calcite is a natural expected product of sodium silicate reactions in concrete, quartz and dolomite were not. Further testing of an early sample that did not contain silicates, showed that the black interface development was almost all carbonate crystal structures but not fully developed into the Dolstone minerals.

The adhesion phenomenon was interesting but unknown until mechanical testing was conducted. The proof was when the official ASTM pull test on July 28 proved that the adhesion phenomenon was real science July 28^{th}, test compression samples which had been prepared in standard ASTM sized 4 inch×8 inch plastic tubes, were tested at different ages. During the destructive compression test, the resulting samples exhibited very high strengths and stone-like characteristics. When they finally failed, the samples formed shards instead of crumbling, more consistent with a stone than with traditional concrete. As strength was a not primary consideration, no specific strength objectives were expected, however some of the samples tested high as 75 MPa at 14 days which indicates that a hard wearing surface is produced.

One embodiment of the relative proportions of a cementitious composition comprise
10 kg of Portland cement
25 kg of Sand
1 kg of Silica fume or equivalent pozzolanic material
1 kg of fly ash (type F)
50-500 ml of superplastizer (PCE)
25-50 ml of SodiumSilicate (PMT) and
2-4.5 kg water.

Optionally, the composition can also include aggregate, in the order of up to about 15 kg small aggregate to 10 kg of the Portland cement to make the preferred thin overlay variation of VokeStone.

Late in the initial testing process, a round of testing was completed with a commercial bulk mix of CSA type 10 and 15% fly ash. The precipitating and adherence effect was present but much reduced. There appears to be a fundamental difference between CSA types 10 and 50 that were tested, which certainly shows that the type of Portland can affect the outcome of adhesion. The tests were a reproduction of the original Sakrete and Portland mix that adhered, hence, these cements would have been predominately CS3 containing CSA type 10 Portland cement so we know that the other forms of Portland cement work but the best results come from the predominately CS2 cements also known as sulfate resisting cements.

In summary, using application combination of common Portland Cement, Pozzolanic materials and Sand combined with a superplasticizer (Poly Carboxyl Ether), a rudimentary mechanical bond layer is formed. The adhesive bond layer is within the carbonate family. Bond layers of this simple chemistry are most useful when used as a bond layer with or without subsequent overlays of more traditional concrete mixtures. The use of both crystalline and amorphous Pozzolanic materials and sand are combined resulting in engineered variability in the performance of the end products. A wide variation of compositions have shown that bond layer will adhere to conventional concrete tested. However a cream finish, common on finished concrete surfaces, exhibits little structural use and a tendency to disbond which reducing the overall effectiveness of the overlay. A preferred method is to expose the aggregate in the parent material, whether by mechanical abrasion or existing weathering. Forms of suitable mechanical abrasion or exposure include shot blasting or diamond grinding, as other more aggressive methods such as scarifying result in a lower surface integrity of the parent material.

Using the same chemistry described above, a thin layer of two times thicker than the largest aggregate diameter or much thicker may be poured on a floor. The hardness of this layer is directly related to compressive strength which has been dependent on a ratio of water to cement and, with the proportion of superplasticizers to total water content, and the use of silicate chemistry, results in observed strengths of 75 MPa in 14 days. Careful control of aggregates and wet troweling, to ensure sand comes to surface and reduce surface porosity, results in a hard surface. This surface may be further hardened with select silicate treatments.

The thin overlays described above are quite complex from the engineering point of view. There are three interrelated properties that must simultaneously happen to make a successful thin overlay. The interface must bond and be able to transfer shear stress. The resultant surface must be commercially useable by the end user. The volume of the overlay must be of sufficient strength to spread point loads without crushing the matrix.

Long range crystallinity is demonstrated with a natural rock matrix of silicates and carbonates, typically quartz, calcite and dolomite. In the case of VokeStone, the same highly crystalline silicates and carbonates are formed, typically quartz calcite and dolomite. Functionally, when sodium silicates are added, the sand portion becomes indistinguishable from the basic cement matrix and even holding broken sections to bright light reveals the crystalline nature. The formation of these phases will push the long range crystal order across an interface over a period of time. Observations have shown that for mixes that did not exhibit mechanical bonds in three days, full chemical bonds were developed well into the parent material within a week. The observation arose when test swatches 15a and 15b failed the three day adhesion test, it was left on the floor for two weeks, when it was discovered that it had fully adhered. Some compositions take a very long time, such as a month or more to develop but over time, still make fully crystalline interfaces when no mechanical bond was initially present. The previously described mechanical interfaces are analogous to metallurgical results produced in brazing metal surfaces but the chemical interface described is akin to welding metal surfaces.

The process of how the chemical products of the reaction become crystals analogous to minerals should be described as mineralization. There is a problem with the use of this term as Geoscience never addresses how minerals are created, only what can observe at this time. The basic principle is that natural rocks and minerals are created over eons so there was no need to define a dynamic process. Hence what should be the correct term for a dynamic process, “mineralization”, has been used instead to describe the mineral ore value of natural rock formations. Describing a process that is not in a reference book or paper is a challenge.

While most recipes for the product are self-leveling allowing very flat surfaces to be produced, the product can be used in other ways as well. The product lends itself to formwork and can be used both as a new product but also for repair as it adheres well to steel as well as concrete. The basic chemical nature of the carbonates protects steel from corrosion if water movement does not occur.

The very nature of VokeStone adhesive bonding characteristics lend itself to extension of previous cement work or adhesion to partially cured “green” concrete during long time lapses result in partial cures during large pours whereas interfaces with this new product can become mechanically indistinguishable from previous layers. This allows the transfer of stresses across a bond which allows the Vokestone to act as an extension of the parent material.

Of interest to industry is VokeStone will present a superior method of grouting machinery for the above reasons. The use of epoxy grout does not offer many of the distinct advantages of VokeStone as it can only mechanically adhere to interfaces. The chemical adhesion and self-leveling characteristics of variations of VokeStone provide superior performance in vibration applications. Proof of concept of this was the use of the VokeStone technology to grout a tile wall with a commercial sanded grout. The process allowed easier application of the grout but the resultant mixture is far harder and more inert than standard grouts. The properties of hard and more inert were manifest as the hardened product is not removable during post construction phases. The chemical changes have rendered the grout lines to be superior to standard soft permeable grouts. These are the same desirable properties that industrial grouts try to achieve.

Chemical and Thaw Resistance.

The accepted damage mechanism from freeze thaw action on concrete is the expansion of water that wicks into voids in concrete. Water that expands in pores, voids and cracks exhibits very high tensile stresses, exactly the property concrete is poor at resisting. The use of water sealers on the surface only partially deals with these problems and can create a barrier that allows damaging water to collect which will result in further acceleration of damage. Chlorides have long been known to actively participate in degradation mechanisms as they depress the freezing point of water allowing water migration at temperatures that will exacerbate the freeze thaw damage

Herein, the material disclosed herein demonstrates very strong resistance to free migration of water which makes it resistant to damage from soluble salts such as chlorides. That material is also resistant to the action of freeze thaw as samples put into and removed from a freezer in both wet and dry conditions over three day cycles for 2 months did not experience any degradation and the interfaces were not damaged as expected with mechanical bonds. There appears to be no capillary action of liquid water possible and would be considered to be very low permeability. The low permeability indicates that some water vapor would move through VokeStone making permeability similar to natural dolomite, or limestone. An outdoors demonstrator was poured in August 2016 and has been through many natural freeze thaw cycles as the site of the research in a chinook zone. At the time of filing, the degraded concrete still has a well adhered VokeStone coating.

Production of Artificial Sedimentary Rock.

The production of artificial sedimentary rock is another benefit of the process, which depending on PCE loading of mixture can result in carbonate and silicate rocks of very high crystallinity. These products that may be divided into two groups: Art and Architectural products and Structural products. Art Products are produced for the high quality surface finish common in monument and construction industries Functional Structural products are cement structures that need low permeability such as tanks or containment ponds. Thick sections have been poured with the bulk properties appearing homogenous throughout the mixture depth in low water content mixes. Fractures of the materials, generally show sharp edges common to crystalline material as opposed to the normal granular crush of concrete test samples

There is a limitation where there is a float layer that forms that must be engineered out or allowed to form in an area where it does not affect the final product.

The surface finish for the Art aspect of the material shows as the concentration of PCE increases. A range of high quality surface finish modes up to and including similar appearances to fine grained granite demonstrate a very fine finish can be achieve by pouring directly against plastic which is very suitable for monuments such as markers, remembrance or other monuments. Tests have shown the higher PCE variations of VokeStone would lend themselves to the intricate details of sculpture and architecture very well.

Concrete does not normally lend itself to containment of liquids unless it is lined. Tanks or other non-pressure type vessels have been produced as commodities for generations but the commonality is that they all leak due to water ingress or egress. Waterglass surface treatments have been used for long periods of times to attempt to control this problem. Tanks built out of VokeStone would be low permeability from the outset and could be built to very high strength levels to reduce the amount of concrete used. Cisterns, large diameter water pipes and Septic tanks are classic examples where in one circumstance we try to keep potable water in and the other where we try keep the effluent out of groundwater so permeability is a significant question. Similarly, various formulations of VokeStone, material would be of particular value in the storage of salts and nuclear waste. Whether cast in insitu, or precast, VokeStone can be applied to many engineering applications

1) A fundamental method of adhering manmade cement based material to existing silicate, carbonate or manmade concrete material as using varied compositions as outlined in the preferred embodiments.

2) A wide range of engineered applications are available based on the range of preferred embodiments and testing

3) Intermediate Bond layers for adhesion of conventional concrete may be engineered

4) Interpass layers between partially cured concrete pours on new construction would result in seamless extension of poured structures

5) The bond layer adhesion may be engineered to a range from simple chemical products such as magnesium carbonate or may be fully developed into synthetic mineral bond

6) The long range order of the crystal structures of a mineral bond can pass across an interface.

7) The manmade material can be applied to form technology to make bulk repairs or alterations to concrete

8) A fundamental method of creating an array of manmade based materials from industry approved concrete raw materials to create a novel variety of high strength, low permeability materials with the characteristics of a synthetic sedimentary rock has been created using materials outlined in preferred embodiments and testing.

9) The existence of synthetic sedimentary rock has been qualified using SEM/EDX, XRF and XRD methods

10) The extension of PCE plasticizer science shows that water to cement ratio is only a part of the phenomenon and plasticizers play a major role in the final product crystallinity and strength.

11) The use of sodium silicate formula, in this case the proprietary PMT, was successful in creating long range order in normally semi amorphous materials.

12) This manmade based product is the only proven method of creating synthetic materials in the carbonate and silicate families.

13) This manmade material demonstrates long range order consistent with extension of long range atomic order referred to in material science as crystallization.

14) This manmade material is suitable for industrial precasts including but not limited to where strength and low permeability to water or other liquids are desirable properties.

15) This man made material is suitable for insitu application including but not limited to where strength and low permeability to water are desirable properties.

16) This manmade material may be formulated to result in products that have a high aesthetic appeal useful in Art and Architecture where the PCE concentration may be varied for both strength, percentage of crystallization and Art considerations as need be

17) A reliable method of creating a thin overlay or forming material has been created for permanent repair of existing concrete surfaces by combining aspects of the previous two major claims as there are two separate surfaces performing different functions, adhesion, loadbearing while the volume of the material performs a separate function of structure and geometry.

18) Thin overlays may be adjusted to meet the local engineering requirements through engineering considerations under preferred embodiments

19) Engineering requirements can be tailored for surface finish, speed of return to service

20) When the manmade material is used for grouting applications, engineering requirements can be selected for the resultant grout to exhibit superior vibration resistance, water resistance as well as compressive strength.
